(19) United States
(12) Patent Application Publication
(10) Pub. No.: US 2006/0223464 A1
(43) Pub. Date: Oct. 5, 2006

(54) Method for switching a power amplifier

(76) Inventor: Michael Louis Frank, Loveland, CO (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/093,900

(22) Filed: Mar. 29, 2005

(51) Int. Cl. H04B 1/04

(52) U.S. Cl. 455/127.4; 375/328

(57) ABSTRACT

A power amplifier switching circuit includes a transmission filter. A first switch having an input connects to the transmission filter. A second switch connects to a first output of the first switch. A receive portion of a duplexer connects to an output of the second switch. A power amplifier receives a second output of the first switch and an output matching network. A transmit portion of duplexer interposes the output matching network and and an input of a third switch. A phase shifter interposes an antenna output and an input of a second switch.

### BACKGROUND

Code Division Multiple Access (CDMA) type handsets use proximity to minimize the amount of power that a link must broadcast. As the distance between a handset and a base station is reduced, both components lower the power that they transmit. On average, a CDMA link requires approximately 1% of the peak power available. FIGS. 1a-b illustrates the user power requirement. From FIG. 1b, it is clear that the handset transmits less than 0 dBm (1 mW) half the time, and rarely is required to transmit 23 dBm (200 mW). Due to this dynamic range requirement, the transmitter must be able to operate both in a very high power mode and a very low power mode. Since the power amplifier is a major user of power, its efficiency over this entire range is critical. Simultaneously, the transmit Tx power can be reduced, the available reception Rx power is much higher. Thus the receiver may require commensurately less sensitivity.

Switches are used to switch around a power amplifier but they are difficult to implement. This requires a state when the power amplifier is on, transmitting at high power, while the switch is open. When the power amplifier is off, the switch would be closed, completing a path around the power amplifier.

CDMA is very sensitive to any distortion in the transmission. When the power amplifier is transmitting at high power, the open switch will have a high RF voltage across its terminals. It is in this condition that the switch generates distortion. To illustrate, when the power amplifier is transmitting 0.5W of CDMA, the peak RF voltage can be 8V in 50 ohms while the control voltage can be as little as 2V. The switch must be designed to remain open while the RF voltage is much higher than the control voltage. This RF voltage can partially close the switch and thus generate distortion. Making the switch larger can mitigate this but the distortion cannot be eliminated. Larger switches are more expensive. Testing the switch for this distortion can be very difficult. Closed switches do not distort much because there is a very little RF voltage across the terminals.

### SUMMARY

A power amplifier switching circuit includes a transmission filter. A first switch having an input connects to the transmission filter. A second switch connects to a first output of the first switch. A receive portion of a duplexer connects to an output of the second switch. A power amplifier receives a second output of the first switch and an output matching network. A transmit portion of duplexer interposes the output matching network and an input of a third switch. A phase shifter interposes an antenna output and an input of a second switch.

### BRIEF DESCRIPTION OF THE DRAWINGS

FIGS. 1a-b illustrate the power requirements of CDMA type handsets.

FIG. 2 is a circuit diagram of the prior art.

FIGS. 3a-c illustrates an embodiment of the present invention.

FIG. 4 illustrates an embodiment of the present invention.

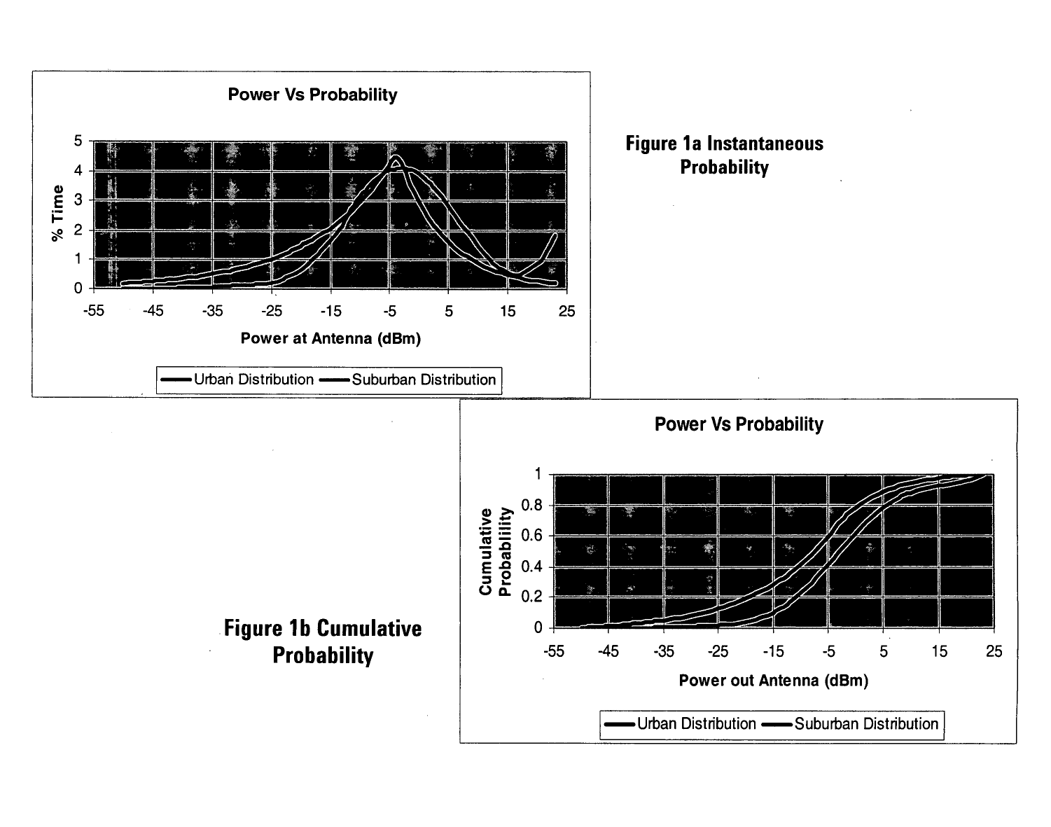

### DETAILED DESCRIPTION

There are many methods employed to build efficient broad range power amplifiers. Each method entails tradeoffs between the high and lower power states between higher complexity and simplicity between added cost and lower functionality. If the requirement for low power efficiency is removed from a PA then the tradeoff can be re-evaluated to the benefit of the high power efficiency.

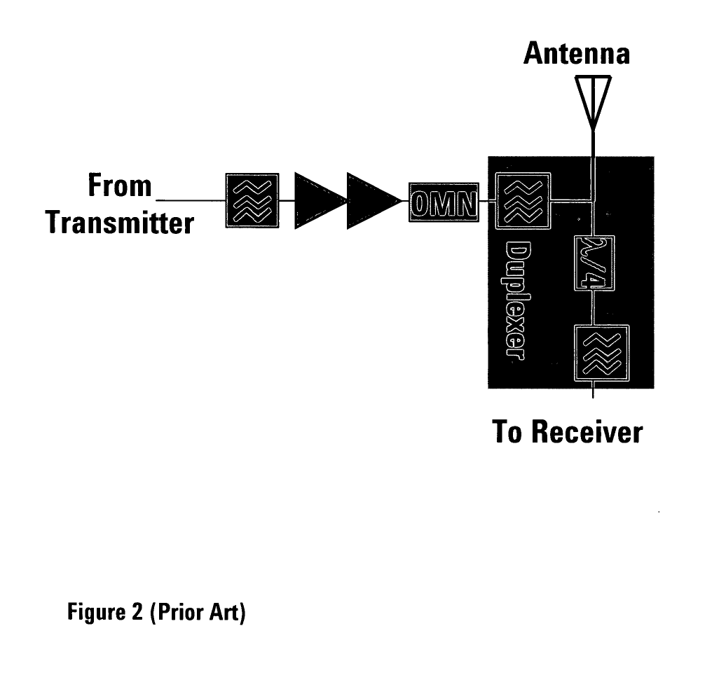

If the switches were always inserted into the transmitter where the RF voltage is low, then there would be no distortion, and so small, untested switches could be used. By incorporating the switches into a duplexer, this can be accomplished. FIG. 2 illustrates a prior art power amplifier used in conjunction with a duplexer. The power amplifier could be replaced with a switched power amplifier but would suffer all the problems related above.

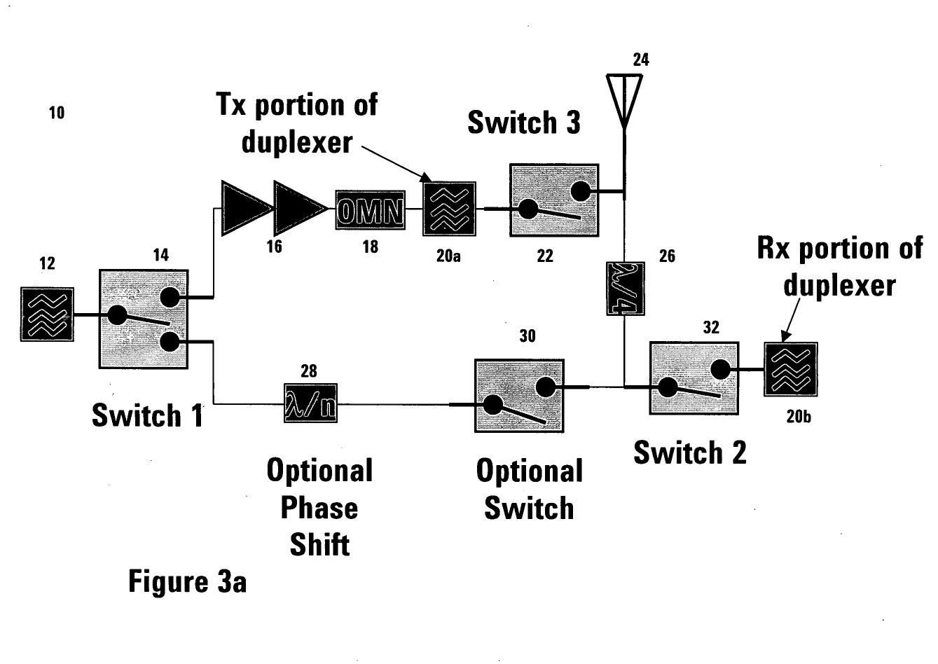

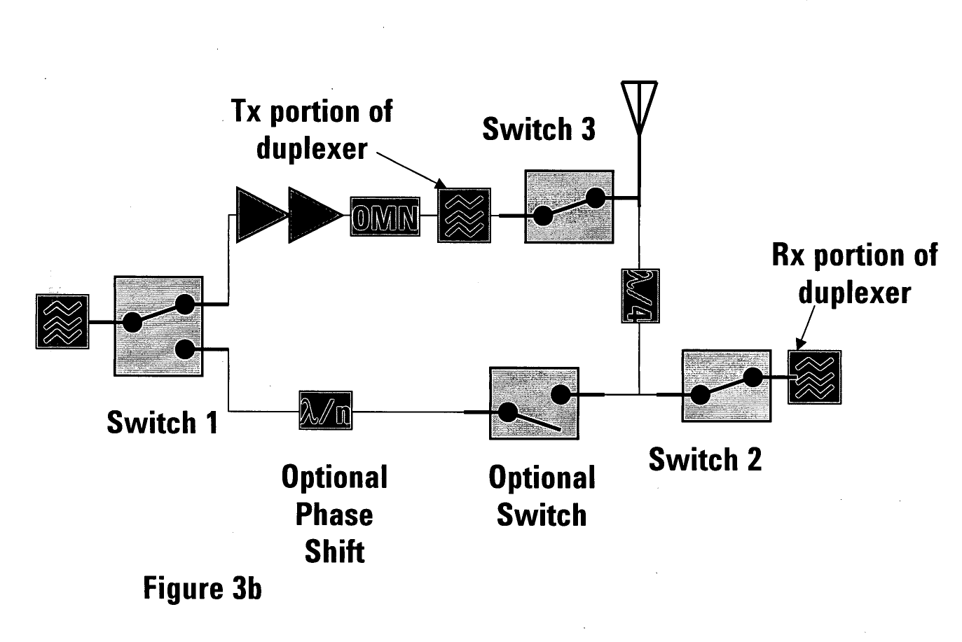

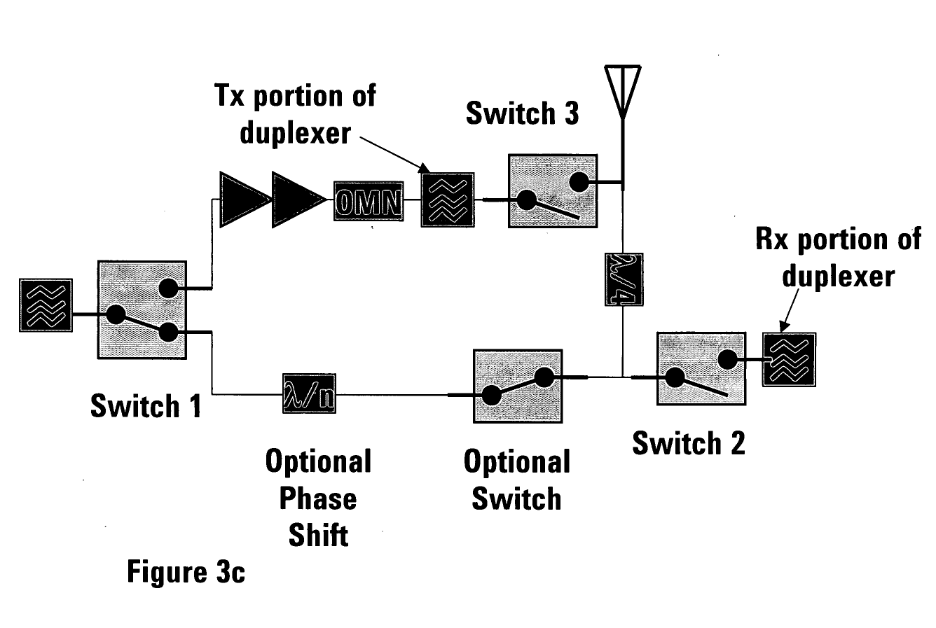

FIGS. 3a-c illustrate an embodiment 10 where there are open switches only where the RF voltages are low. A transmission filter 12 connects to the input of a first switch 14. A first output of the first switch 14 connects to the input of a second switch 32 that has an output connected to the receive portion of a duplexer 20b. A power amplifier 16 interposes the second output of the first switch 14 and an output matching network (OMN) 18. A transmit portion of a duplexer 20a connects between the OMN 18 and the input of a third switch 22. A phase shifter 26 interposes the output of antenna 24 and the input to the second switch 32.

In this embodiment, the first and second switches are interposed by an optional phase shifter 28 in serial connection to an optional switch 30.

The first switch 14 is positioned prior to the power amplifier 16 and only sees signals below 10 mW. The resulting RF voltage is only 1.2V and so the switch 14 remains open when required, without generating distortion.

The output of the second switch 32 is connected to the Rx filter 20b of the duplexer which is a short circuit at the Tx frequency. The lambda/4 phase shifter 26 protects the Tx path from this short circuit, as in the duplexer 20. Consequently, there is never a high RF voltage at this switch 32.

The third switch 22 is only open while the transmitter is off. Again, it has not more than 1.2 V RF maximum. None of the open switches ever experiences RF voltages that are high compared to the control voltage.

The first switch 14 must be an high isolation switch. When open, the switch 14 must have much more isolation than the power amplifier has gain. This ensures stable operation while in the gain state.

The second switch 32 is a low isolation switch. When the power amplifier is off, the RX filter must not short the alternative Tx path. Thus, there must be sufficient isolation in the second switch 32 to prevent this shorting. However, the Rx signal from the base station must pass through to the receiver. Approximately 10 dB of isolation will accomplish both purposes.

The third switch 22 must similarly protect the alternative Tx path from a poor load, e.g. the Tx portion of the duplexer 20a. The third switch 22 requires just enough isolation to ensure sufficient transmission, but should have minimum loss in the closed state so as not to affect the efficiency of the power amplifier 16.

Combining the power amplifier bypass switch with the duplexer removes the requirement that the switch must remain open and non distorting while experiencing high RF voltage. This allows for a complete shut down of the power amplifier and extends talk time when used in a handset.

The optional phase shifter 28 may be positioned between the first and second switches 14, 32. This would compensate for any abrupt phase change when toggling between the power amplifier and the switched state.

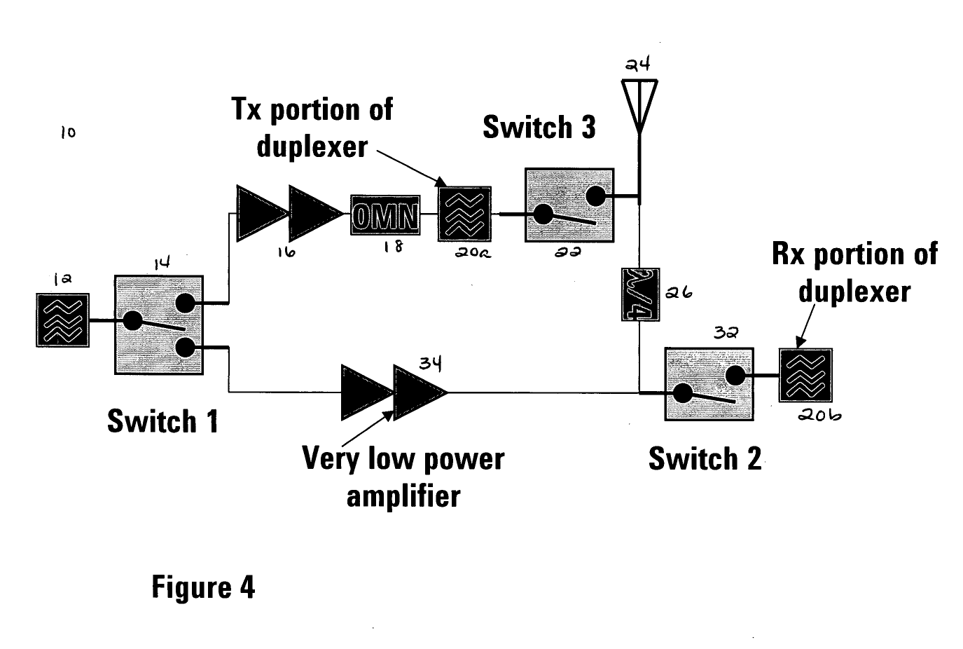

FIG. 4 illustrates an alternate embodiment. In this embodiment, a low power amplifier 34 is positioned between first and second switches 14, 32. This amplifier 34 would provide similar phase delay as the primary amplifier 16, again eliminating the phase discontinuity under switching.

1. A device comprising:
a transmission filter;
a first switch having an input connected to the transmission filter;
a second switch connected to a first output of the first switch;
a receive portion of a duplexer connected to an output of the second switch;
a power amplifier receiving a second output of the first switch and an output matching network;
a transmit portion of duplexer interposing the output matching network and and an input of a third switch; and
a phase shifter interposes an antenna output and an input of a second switch.

2. A device, as defined in claim 1, further including a serially connected second phase shifter and third switch that interposes the second output of the first switch and the input of the second switch.

3. A device, as defined in claim 1, further including a low power amplifier interposing the second output of the first switch and the input of the second switch.

4. A device, as defined in claim 1, wherein:
the first switch is a high isolation switch; and
the second switch is a low isolation switch.

5. A device, as defined in claim 1, wherein the first and second switches are separated by at least 10 dB.

6. A device, as defined in claim 5, further including a serially connected second phase shifter and third switch that interposes the second output of the first switch and the input of the second switch.

7. A device, as defined in claim 5, further including a low power amplifier interposing the second output of the first switch and the input of the second switch.
